(19) United States
(12) Patent Application Publication
(10) Pub. No.: US 2003/0224682 A1
(43) Pub. Date: Dec. 4, 2003

(54) Compressible gasket and flame shield

(76) Inventors: William John Luerman, Voorheesville, NY (US); Dorothy Jean Stuart, Clifton Park, NY (US)

Correspondence Address: BIRCH STEWART KOLASCH & BIRCH, PO BOX 747, FALLS CHURCH, VA, 22040-0747, US

(21) Appl. No.: 10/158,862

(22) Filed: Jun. 3, 2002

(51) Int. Cl. B32B 17/06; B27N 9/00; B32B 29/02; B32B 27/18

(52) U.S. Cl. 442/136; 442/180; 442/381; 442/412; 442/402; 428/920; 428/921

(57) ABSTRACT

A gasket to seal a service door of an appliance. The gasket is formed from a needled glass mat attached to a glass paper by random needling. The mat is very compressible to seal the door to the appliance to prevent the entrance of flammable vapors and the egress of exhaust. The glass paper provides structural strength and carries a vermiculite coating that protects the surface nearest the flame. Random needling retains the structural strength of the product to prevent it from tearing.

### BACKGROUND OF THE INVENTION

1. Field of the Invention

This invention relates generally to a gasket and flame shield material and more particularly, to a gasket and flame shield for a combustion chamber of an appliance.

2. Description of the Background Art

A number of appliances in the home, as well as in commercial or industrial settings utilize power sources which are burned. This would include natural gas, oil or other burning fuels. The presence of a flame presents a number of hazards in terms of fire safety and in protection against noxious fumes. In order to ensure the safety of the appliance, it is desirable to seal the flame area so as to prevent the ingress of flammable materials and to prevent the egress of undesirable fumes.

Such flames may be used in a number of appliances, including hot water heaters, furnaces, clothes dryers and other commercial and industrial heaters or dryers. One particular problem which has become more common is the problem of storage of flammable materials, such as gasoline in an area near such an appliance. If, for example, an appliance is located in a garage area of a home, it is possible that gasoline or other volatile materials used for lawnmowers or other equipment which might be stored in the garage could give off flammable vapors which could come into contact with the flame of the hot water heater. It is therefore desirable to seal the combustion area of the appliance to prevent flammable vapors from reaching the flame. It is also sometimes desirable to seal the combustion area to ascertain that exhaust from the flame does not leak into the home in case the ventilation of the appliance becomes blocked. While the combustion area of the appliance is normally surrounded by a metal or other non-combustable wall, there often provided a service opening for maintenance and repair of the combustion area.

While this opening is usually closed with a door of similar material, a gasket is necessary in order to completely seal the combustion chamber. At least two problems are presented providing this gasket. First, the combustion chamber wall is often round which makes sealing more difficult and secondly, the presence of the flame makes the choice of gasket materials more difficult.

Typical gasket materials are designed to compress in thickness to effect a seal. That behavior is insufficient when the wall and door are nested curves. When a flat gasket is flexed to meet that curve, it is forming a shape with a smaller inside surface than the outside surface (different radius of curvature for the inner and outer surfaces). The gasket material must deform to reduce the surface area on the inner curve. For traditional gasket materials, the material may fold on the inner surface to compensate for the compression. These folds leave gaps in the seal, which could leak gases from the combustion chamber. A gasket material that can compress along its length will reduce the inner surface area without folding and avoid such gaps.

Also, any materials used in the gasket must resist damage by heat or flames. The heat from the burner will burn off any organic adhesives and binders; yet, the gasket must not fall apart if removed. The used gasket must retain sufficient structure to be reinstalled. Gaskets for this application must be held together with mechanical and inorganic bonds.

### SUMMARY OF THE INVENTION

Accordingly, one object of the present invention is to provide a compressible gasket to seal a door.

Another object of this invention is to provide a gasket material for sealing a door in an appliance.

A further object of this invention is to provide a composite gasket material that is flame-resistant.

A still further object of this invention is to provide a seal on a door to an appliance to prevent the ingress of volatile materials, or egress of exhaust fumes.

A still further object of this invention is to provide a new and improved gasket that is compressible, retains its strength under high temperature use conditions, and may also have a flame-resistant coating.

Briefly, these and other objects of this invention are achieved by providing a gasket made of a needled glass mat attached to a glass paper by random needling. In one embodiment the paper is coated with vermiculite to provide flame-resistance. In another embodiment, the coating is not necessary because the gasket is not exposed to flame.

### BRIEF DESCRIPTION OF THE DRAWINGS

A more complete appreciation of the invention and many of the intended advantages thereof will be readily obtained as the same becomes better understood in reference to the following detailed description considered in connection with the accompanying drawings, wherein:

FIG. 1 is a front view of a door mounted in the wall of an appliance;

FIG. 2 is a top view of the door and gasket arrangement of the present invention;

FIG. 3 is a front view of the first embodiment of the gasket of the present invention;

FIG. 4 is a front view of a second embodiment of the gasket of the present invention; and

FIG. 5 is an edge view of a gasket according to the first embodiment of the present invention.

### DESCRIPTION OF THE PREFERRED EMBODIMENTS

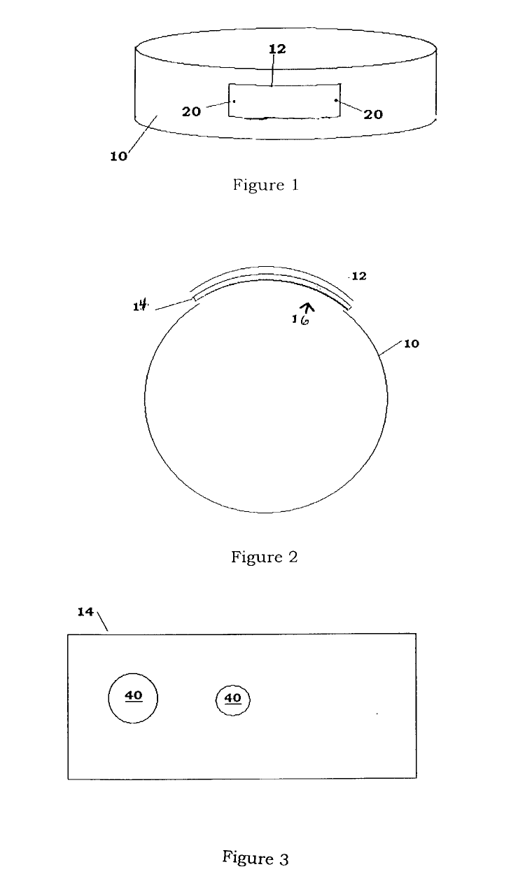

Referring now the drawings, wherein like reference numerals designate identical or corresponding parts throughout several views. And more particularly to FIG. 1 thereof, wherein the outer wall of an appliance 10 is shown. Only a portion of this wall is shown in FIG. 1, namely that part near the burner, it being understood that the main portion of the appliance would extend beyond this section. In order to access the burner area, a door 12 is provided. Screw holes 20 are provided on either end to hold the door in position against the wall by way of screws (not shown). As shown in FIG. 2, the door 12 covers the service opening 16 in the wall 10 of the appliance. A gasket 14 is placed between the door and the wall in order to seal the combustion area from the entry of flammable gasses.

FIG. 3 shows a front view of the gasket 14. Holes, 40 may be provided in the gasket as necessary for the appliance for any wires, pipes or other items to pass therethrough, or for observation.

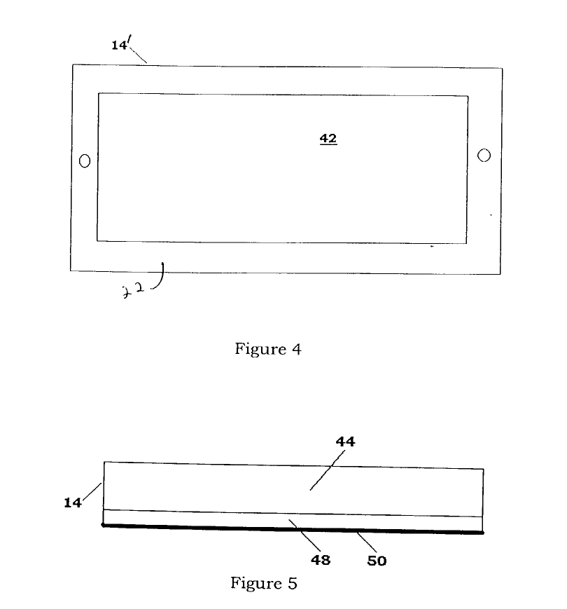

FIG. 4 shows a second embodiment of the gasket, 14′. In this case, the gasket does not cover the entire door, but only the border portion 22 so that the space between the wall and the door is filled. A central portion 42 of the gasket is left open so that the central portion of the door is uncovered.

FIG. 5 shows a cross sectional view of the gasket material. The gasket is made of a three layered material. The outer layer 44 is a matted material such as a glass fiber mat. The central layer 48 is a glass paper material that is optionally covered with a vermiculite coating layer 50 for flame-resistance. This composite material is very suitable for the purpose of a gasket in a hot environment. The mat material 44 may be compressed evenly without puckering, and accordingly, will completely fill the space between the door and the wall so as to seal it. Glass paper 48 provides structural stability for the mat, and allows it to be easily cut and still hold its shape. The vermiculite coating 50 is applied on the side of the burner so as to protect the gasket from the flames.

In forming the composite material, the glass mat is first needled so that the mat has some structural stability. The needling is performed by extending a sharp thin object with barbs on the sides through the mat and retracting it. This is performed a number of times and by a number of needles and if desired, can be done from both sides. In doing this, the fibers become entangled, so as to form a cohesive mass. Prior to needling, the fibers are very loose and easily fall apart.

The fiber mat which is used is preferably made from glass although other types of fibers could also be used. The mat is approximately ¼ inch thick, with the fibers having a diameter of roughly 9 microns. The fibers may be coated with starch or other sizing to allow needling. One suitable material is Techmat Style A04065 from BGF. This material also has a nine pound/cubic foot density. Other fiber mat materials are also usable.

The glass mat is usually constructed by forming loose fibers onto a batting and needling from both sides to form an entangled mat. The mat is then matched up with a glass paper and needled again.

Needling is used to mechanically bond the mat and paper to avoid problems of adhesives that burn away. To avoid excessive damage to the paper, needling is directed from one side only, so that the fibers of the mat 44 are pulled through the paper 48 to form tufts, or a fuzzy surface from the fibers on the side of the paper 48 away from the mat. The tufts, which extend beyond the surface of the paper, melt back to the face of the gasket and either fall off, or form small balls on the surface when they are exposed to the flame.

The glass paper that is utilized is preferably a 30 mil electrical grade glass with 11 micron fibers. Other grades such as 7 micron or 13 micron glass could also be used. The glass is a chopped strand textile fiber as opposed to glass wool. The binder on the glass is a hydrocarbon polymer used at low levels to reduce flammability. Materials other than glass paper could also be used as long as they are relatively thin, do not sustain combustion, and maintain their shape in processing.

The glass paper is preferably a wet-laid product to achieve a thin product with a flat, smooth surface.

When needling the mat to the paper, the needling density is about 50 punches per inch, and the fiber penetration depth is greater than ⅛ of an inch. These conditions ensure the glass paper is firmly attached without excessive damage to the glass paper.

In the first embodiment, a vermiculite coating 50 is applied to the inner surface of the glass paper to protect it from the flame. This coating is applied prior to needling the glass paper to the mat. The coating readily adheres to the glass fibers in the paper without organic binders. Although this is shown as a surface coating, vermiculite could also be used to saturate the glass paper before it is needled to the mat. The vermiculite does not apply well directly to the mat 44 due to the high compressibility and fuzzy surface on the mat. Accordingly, the glass paper 48 provides a suitable surface for the flame-resistant layer.

The vermiculite coating is preferably Microlite HTS from W R Grace. This coating is applied as a surface treatment, or it can be used to saturate glass paper. When coating, it is preferred to have 18-35 pounds/2880 sq. ft. In saturating, it is preferable to have 20% vermiculite by weight. It is also possible to incorporate the vermiculite into the paper by including it in the fiber stock when forming the paper.

The second embodiment of the present invention, shown in FIG. 4 is made of similar material, but is applied only around the edge of the door. Thus, this material fills the space between the door and the wall but does not cover the central area of the door. Since the wall protects the gasket material, the gasket cannot come into direct contact with the flame and the vermiculite coating is not necessary. Accordingly, in the second embodiment, it is possible to utilize merely a glass mat and glass paper composite without the vermiculite coating.

The glass mat is still necessary for structural support. The needled mat alone does not hold its shape very well and is easily stretched out of shape. By applying a glass paper to this relatively weak material, the structural stability of the gasket is much improved.

The structural contribution from the glass paper is important to ensure the cut shape of the gaskets matches the shape of the door. It is preferable to cut the gaskets using well-known die cutting techniques. The gasket material is pulled into the die cutter, then stamped with a die into gaskets that are shaped to match the any holes in the door. Unfortunately, this manufacturing process easily stretches needled mats, giving thin spots in the mats and distorting the gasket shape. The glass paper has strong resistance to stretching, which it retains after needling to the mat. The glass paper prevents the gasket material from distorting readily.

This resistance to stretching is also important during installation of the gaskets. In the second embodiment shown in FIG. 4, the gasket has narrow sides with a large central opening that would readily stretch out of shape under normal handling if constructed of needled mat only. The gasket must cover the border portion 22 without extending beyond the door or over the central portion 42. Once the gasket is stretched, either the installer would try to push the stretched gasket into place with a potential for leaks, or he would have to discard the gasket. Adding the glass paper to the construction of the gasket greatly improves the durability of the gasket under installation.

In the first embodiment with vermiculite shown in FIG. 3, the sheet is a large piece with smaller holes. That part is less likely to stretch during installation, yet the glass paper is still necessary to carry the product through the die-cutting process and to carry the vermiculite coating.

When the mat 44 is applied to the paper 48, the needling process can degrade the structure of the glass paper and the vermiculite coating, and it is important to minimize the effect on the gasket properties by randomizing the needling punches. That is, if these small holes align too well, the gasket properties would suffer. The glass paper would tear more easily and would not deliver the intended gasket structure. Also, the vermiculite coating, when applied as a surface film, would be susceptible to cracking, which would leave gaps in the flame protection.

Controlling the needling process will randomize the needle punches. The needling process normally utilizes a fixed set of needles in a board so that they move together vertically, while the material moves horizontally relative to the needles. It is important to make certain that the timing of the material movement and the movement of the needles is not synchronized so that adjoining areas which are needled are offset from each other and so that the needle punches are not in straight lines.

While the present invention has been described in terms of appliances having burning fuel sources, such as hot water heaters, furnaces and clothes dryers, this gasket material can be used in any number of other situations. Thus, the gasket can be used in any situation for sealing a door whether a flame is present or not. Thus, it can be used to seal a door opening in any appliance or even in structural doors. It can also be used between parts of housing walls to provide good seals to prevent gas flow therethrough.

Since the material is flameproof, it could be used in fire protection applications such as ship fuel insulation. It could also be used in cable trays to protect power wires from fire in critical areas like nuclear power plants, and in accordian room dividers.

The material without vermiculite could be used in narrow strips to wrap steam trace lines. The flat surface also would accept the application of foil and pressure sensitive adhesives so that the material could be used as insulation in appliances such as crockpots where the high temperatures require a foil lining.

Numerous additional modifications and variations of the present invention are possible in light of the above teachings. It is therefore to be understood that within the scope of the appended claims, the invention may be practiced otherwise than as specifically described herein.

What is claimed is:

1. A gasket material comprising:
a mat of fiber material;
a sheet material applied to one side of said mat;
said mat and said sheet material being connected by random needling to form-a gasket material.

2. The gasket material according to claim 1, wherein said mat is a mat of glass fibers.

3. The gasket material according to claim 1, wherein said sheet material is wet-laid glass paper.

4. The gasket material in claim 1, further comprising a flame-resistant material applied to said sheet material.

5. The gasket material according to claim 4, wherein the flame-resistant material is vermiculite.

6. The gasket material according to claim 5, wherein the vermiculite is applied as a layer on said sheet material.

7. The gasket material according to claim 5, wherein the vermiculite saturates the sheet material.

8. A gasket for a door of a combustion chamber, comprising:
a mat of glass fibers;
a glass paper attached to one side of said glass mat to form a composite;
said composite being formed into a shape of a door for a combustion chamber for placement as a gasket between the door and a wall of the heater combustion chamber.

9. The gasket according to claim 8 further comprising vermiculite flame resistant material.

10. The gasket according to claim 9, wherein the vermiculite flame-resistant material is a layer on said glass paper.

11. The gasket according to claim 9, wherein the vermiculite flame-resistant material saturates said glass paper.

12. The gasket according to claim 8, wherein the composite is formed to only cover the contact area between the door and the wall.

13. The gasket according to claim 8, wherein the mat is needled by itself before being randomly needled to the glass paper.

14. The gasket according to claim 8, wherein the combustion chamber is in a hot water heater.

15. A method of making a gasket material comprising:
providing a mat of fibers;
needling said mat of fibers;
randomly needling a sheet material to said needled mat to form a gasket material.

16. The method according to claim 16, further comprising applying a layer of vermiculite flame-resistance to said sheet material.

17. The method according to claim 16, further comprising saturating said sheet material with vermiculite flame-resistance before being attached to said needled mat.

18. The method according to claim 16, wherein said mat is a mat of glass fibers, and said sheet material is glass paper.

19. The method according to claim 16, further comprising cutting said mat and sheet material combination in a shape of a door so as to form a gasket for sealing said door.

20. A material comprising:
a mat of fiber material;
a sheet material applied to one side of said mat;
said mat and said sheet material being connected by random needling to form a material.
